(19) United States
(12) Patent Application Publication
(10) Pub. No.: US 2020/0022882 A1
(43) Pub. Date: Jan. 23, 2020

(54) TEETHER

(71) Applicant: Skip Hop, Inc., New York, NY (US)

(72) Inventors: Adlin Aslan, New York, NY (US); Benjamin BEARSCH, Brooklyn, NY (US)

(21) Appl. No.: 16/041,049

(22) Filed: Jul. 20, 2018

(51) Int. Cl. A61J 17/02

(52) U.S. Cl. CPC A61J 17/02

(57) ABSTRACT

A teether for an infant includes a teething member with a stainless steel core completely covered by a layer of silicon. A main body of the teether a defines a through hole, and the teething member is movable between a first position where the teething member is positioned within the through hole of the main body and a second position where the teething member is positioned outside of the through hole of the main body.

### TECHNICAL FIELD

The present invention relates to a teether that can be safely cooled in a freezer. In particular the present invention relates to a teether which includes a metal core surrounded by a coating layer.

### BACKGROUND OF THE INVENTION

Teethers provide a surface which an infant can chew or suck to relieve the discomfort associated with teething. It has also been recognized that coolness is soothing to infants who are teething. Various designs of teethers which are cooled before use have been manufactured and used for years. Current teethers can be uncomfortable for an infant to hold if they are allowed to cool in a freezer. Furthermore, certain teethers include a cooling liquid which can freeze solid, causing a rupture in the teether and resulting leak of the cooling liquid once melted.

### SUMMARY OF THE INVENTION

The present invention relates to a teether that can be safely cooled in a freezer. In particular the present invention relates to a teether which includes a metal core surrounded by a coating layer.

In one exemplary teether of the present invention a teething member is provided which includes a metal core and a coating layer positioned around the metal core. In one exemplary teething member, the metal core is completely covered by the coating layer. In one particular embodiment, the metal core has a diameter of about 60 mm and a thickness of about 2 mm, and the coating layer is formed with a thickness of about 1 mm around the metal core. In some embodiments, the metal core is composed of a non-reactive metal, such as stainless steel. Furthermore, the coating layer is composed of a polymeric material including, but not limited to plastic, rubber, silicon, or the like. In one particular embodiment, the coating layer is formed of silicon. Regardless of the particular material chosen, the coating layer is preferably a relatively soft material suitable for teething.

In some embodiments of the present invention, the teething member is connected to a main body. In particular, the main body defines a through hole and the teething member is connected to the main body such that the teething member is moveable between a first position where the teething member is positioned within the through hole of the main body and a second position where the teething member is positioned outside of the through hole of the main body.

In some embodiments, the through hole of the main body is substantially circular and a channel is defined around the inner surface of the through hole. The teething member is also substantially circular and sized such that an outer perimeter of the teething member is held in place within the channel of the main body. In particular, the outer perimeter of the teething member is sized so that it is frictionally held in place within the channel of the main body and a sufficient force is required to move the teething member from the first position.

In certain embodiments, the teething member includes a hoop which connects the teething member to the main body. The main body defines an annular slot and the hoop surrounds the annular slot of the main body. Once the teething member has been moved from the first position, the hoop is able to rotate within the annular slot. However, the hoop is sized such that the hoop cannot easily move laterally out of the annular slot.

### DESCRIPTION OF THE DRAWINGS

FIG. 1 is a perspective view of an exemplary teether of the present invention with a teething member in a first position within a main body;

FIG. 2 is a side view of the teether of FIG. 1;

FIG. 3 is a perspective view of the teether of FIG. 1 with the teething member in a second position outside of the main body; and

FIG. 4 a partial cutaway view of FIG. 3 showing a metal core within the teething member.

### DESCRIPTION OF THE INVENTION

The present invention relates to a teether that can be safely cooled in a freezer. In particular the present invention relates to a teether which includes a metal core surrounded by a coating layer.

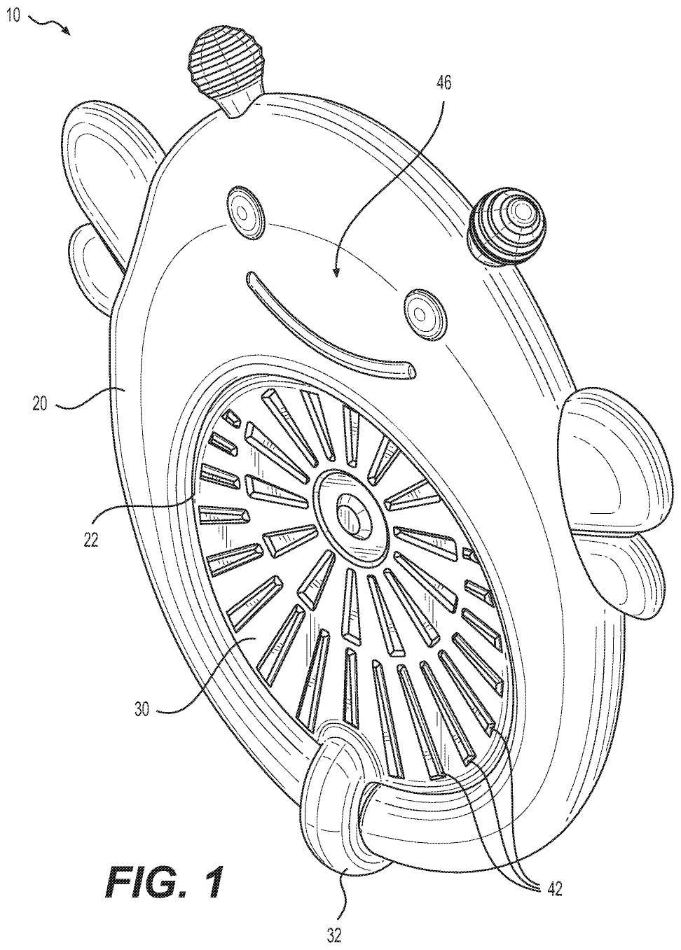

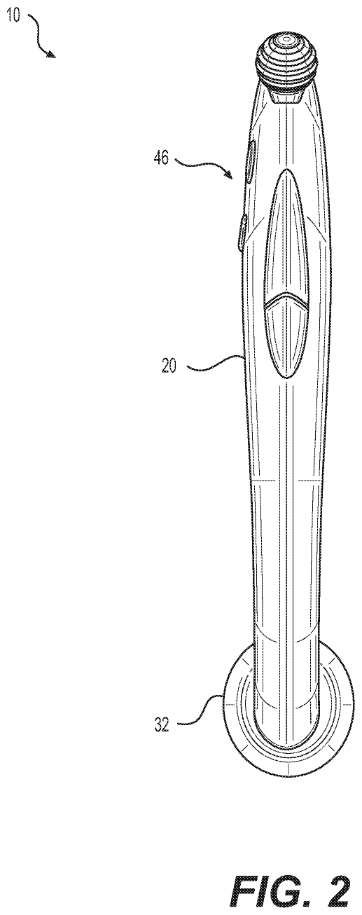

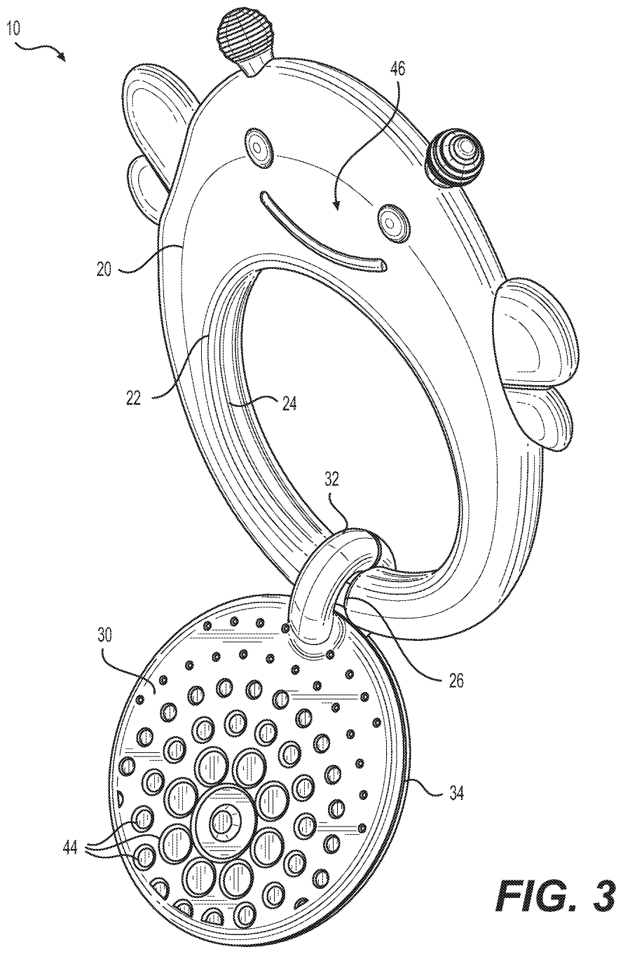

Referring now to FIGS. 1-3, one exemplary teether 10 of the present invention is in the shape of an insect and includes a main body 20 and a teething member 30 connected to the main body 20. In particular, as perhaps best shown in FIG. 3, the main body 20 defines a through hole 22 and the teething member 30 is connected to the main body 20 such that the teething member 30 is moveable between a first position (FIGS. 1 and 2) where the teething member 30 is positioned within the through hole 22 of the main body 20 and a second position (FIG. 3) where the teething member 30 is positioned outside of the through hole 22 of the main body 20.

Referring still to FIGS. 1-3, the teething member 30 includes a hoop 32 which connects the teething member 30 to the main body 20. As perhaps best shown in FIG. 3, in the exemplary teether 10, the main body 20 defines an annular slot 26 and the hoop 32 surrounds the annular slot 26 of the main body 20.

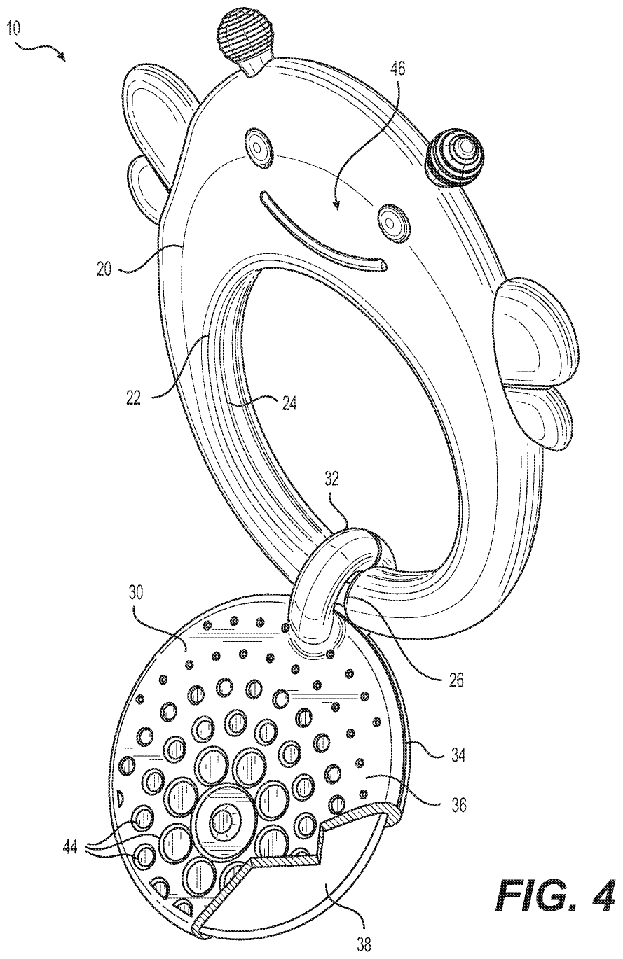

Referring now to FIG. 4, the teething member 30 includes a metal core 38 and a coating layer 36 positioned around the metal core 38. In the exemplary teether 10, the metal core 38 is completely covered by the coating layer 36. In one particular embodiment, the metal core 38 has a diameter of about 60 mm and a thickness of about 2 mm, and the coating layer 36 is formed with a thickness of about 1 mm around the metal core 38. As shown in FIGS. 1, 3, and 4, the coating layer 36 includes a plurality of textual elements 42 on a first side of the teething member 30 and a plurality of textured elements 44 on a second side of the teething member 30, which provide sensory play for an infant. These textured elements 42, 44 are formed in the coating layer 36 itself, and therefore, it is contemplated that with such textured elements 42, 44 the thickness of coating layer 36 actually varies from about 0.5 mm to about 1.5 mm.

In the exemplary teether 10, the coating layer 36 is overmolded over the metal core 38. Furthermore, in some embodiments the hoop 32 connecting the teething member 30 to the main body 20 is composed of the same material as the coating layer 36 of the teething member 30 and, therefore, it is contemplated that the hoop 32 can be formed simultaneously with the coating layer 36 during a single overmolding step. Alternatively, the hoop 32 can be formed separately from the coating layer 36, and can, in some embodiments, be composed of a material different than the coating layer 36.

Referring now to FIG. 3 in particular, the through hole 22 is substantially circular and a channel 24 is defined around the inner surface of the through hole 22. The teething member 30 is also substantially circular and sized such that an outer perimeter 34 of the teething member 30 is held in place within the channel 24 of the main body 20. In particular, the outer perimeter 34 of the teething member 30 is sized so that it is frictionally held in place within the channel 24 of the main body 20 and a sufficient force is required to move the teething member 30 from the first position. Once the teething member 30 has been moved from the first position, however, the hoop 32 is able to rotate within the annular slot 26, but the hoop 32 is sized such that the hoop 32 cannot easily move laterally out of the annular slot 26.

The exemplary teether 10 shown in the Figures is design to resemble an insect. In particular, the main body 20 includes a face 46 opposite from the connection point of the teething member 30. In addition to the face 46, the exemplary teether 10 shown in the Figures further includes other design elements including two antenna and two wings. Of course, the teether of the present invention can resemble other animals without departing from the spirit and scope of the present invention.

With respect to the main body 20 of the teether 10 of the present invention, in some embodiments, the main body 20 is composed of a polymeric material including, but not limited to plastic, rubber, silicon, or the like. The main body 20 can be formed in any number of means known in the art, but in one preferred embodiment, at least the design elements of the main body 20 are formed through overmolding.

With respect to the teething member 30 of the teether 10 of the present invention, in some embodiments, the metal core 38 is composed of a non-reactive metal, such as stainless steel. Furthermore, the coating layer 36 is composed of a polymeric material including, but not limited to plastic, rubber, silicon, or the like. In one particular embodiment, the coating layer 36 is formed of silicon. Regardless of the particular material chosen, the coating layer 36 is preferably a relatively soft material suitable for teething.

In operation, the metal core 38 of the teething member 30 can be can be cooled down, for example by placement of the teether 10 in a freezer, to provide a cold, soothing effect for an infant teething on the teething member 30. The coating layer 36 then functions to protect the child from directly contacting the cold metal. Accordingly, in a preferred embodiment, the coating layer 36 provides sufficient thermal conductivity such that the metal core 38 can be cooled down relatively quickly and also to provide the cold, soothing teething for an infant, but the coating layer 36 provides sufficient thermal insulation to prevent discomfort or harm to an infant once the metal core 38 has been cooled down.

One of ordinary skill in the art will recognize that additional embodiments are possible without departing from the teachings of the present invention. This detailed description, and particularly the specific details of the exemplary embodiments disclosed therein, is given primarily for clarity of understanding, and no unnecessary limitations are to be understood therefrom, for modifications will become obvious to those skilled in the art upon reading this disclosure and may be made without departing from the spirit or scope of the present invention.

What is claimed is:

1. A teether for an infant, comprising:
a main body defining a through hole; and
a teething member connected to the main body, the teething member including a metal core and a coating layer positioned around the metal core;
wherein the teething member is movable between a first position where the teething member is positioned within the through hole of the main body and a second position where the teething member is positioned outside of the through hole of the main body.

2. The teether of claim 1, wherein the metal core is completely covered by the coating layer

3. The teether of claim 1, wherein the metal core is a disc having a diameter of about 60 mm and a thickness of about 2 mm.

4. The teether of claim 1, wherein the coating layer is about 1 mm thick.

5. The teether of claim 1, wherein the main body defines a channel around an inner surface of the through hole, such that, when the teething member is in the first position, an outer perimeter of the teething member is frictionally held in place within the channel of the main body.

6. The teether of claim 1, wherein the main body is substantially circular with an annular slot and the teething member is connected to the main body by a hoop surrounding the annular slot of the main body.

7. The teether of claim 1, wherein the metal core is composed of stainless steel.

8. The teether of claim 1, wherein the coating layer is composed of silicon.

9. A teether for an infant, comprising:
a main body defining a through hole; and
a teething member connected to the main body, the teething member including a stainless steel core completely covered by a layer of silicon about 1 mm thick;
wherein the teething member is movable between a first position where the teething member is positioned within the through hole of the main body and a second position where the teething member is positioned outside of the through hole of the main body.

10. The teether of claim 9, wherein the stainless steel core is a disc having a diameter of about 60 mm and a thickness of about 2 mm.

11. A teether for an infant, comprising:
a stainless steel core completely covered by a layer of silicon;
wherein the stainless steel core is a disc having a diameter of about 60 mm and a thickness of about 2 mm, and the layer of silicon is about 1 mm thick.
